(19) United States
(12) Patent Application Publication
(10) Pub. No.: US 2006/0101088 A1
(43) Pub. Date: May 11, 2006

(54) Method for archiving data

(75) Inventor: Wolf-Georg Frohn, Wolfenbuttel (DE)

Correspondence Address: MORRISON & FOERSTER LLP, 1650 TYSONS BOULEVARD, SUITE 300, MCLEAN, VA, 22102, US

(73) Assignee: SIEMENS AKTIENGESELLSCAFT, Munchen (DE)

(21) Appl. No.: 11/214,035

(22) Filed: Aug. 30, 2005

(30) Foreign Application Priority Data
Aug. 31, 2004 (DE) 10 2004 042 978.2

(51) Int. Cl. G06F 17/30

(52) U.S. Cl. 707/200

(57) ABSTRACT

The invention relates to a method for archiving, particularly long-term archiving, data, where reconstruction (r) of a faulty data record by experts can be avoided by generating redundant data records whose data integrity is monitored continuously in rotation using a hash value signature, and if an error is detected with regard to the data integrity then the affected data record is rejected and the unaffected data record is copied (k) in order to restore the redundancy.

### CLAIM FOR PRIORITY

This application claims the benefit of priority to German Application No. 10 2004 042 978.2 which was filed in the German language on Aug. 31, 2004, the contents of which are hereby incorporated by reference.

### TECHNICAL FIELD OF THE INVENTION

The invention relates to a method for archiving, particularly long-term archiving, data of all kinds.

### BACKGROUND OF THE INVENTION

The storage of security-related data and of production and project data needs to have a high level of reliability. Long-term archiving means keeping uncorrupted data for a time period of between at least six years and at most thirty years plus the time for production or for project handling. The storage media used are primarily servers, CD-ROMs—700 MB—, DVDs—4.7 GB—or double-sided storage media—9.2 GB. The long-term stability of these storage media is approximately ten to fifteen years. Early failures as a result of aging of the storage media are to be expected. In addition, mains failures, copying errors or errors when burning the CD-ROMs may result in unnoticed loss of data. For long-term archiving, regular recopying to new data storage media is indispensable.

A known method for archiving is shown schematically in FIG. 1. The data to be stored are first transferred from the data holder DE to an archive buffer AP. The data in the archive buffer AP are transferred to redundant data storage media in the data archive DA under the protection of the process. In order to be able to detect data corruptions, the redundant data records are transferred t and compared with one another v within the specified time. In this way, it is possible to detect a difference between the two redundant data records. However, a comparison of the data records does not allow detection of which of the two data records has been corrupted, that is to say in which data record the data integrity has been infringed. The original state therefore needs to be reconstructed r by experts before the uncorrupted data record can be copied over to new data storage media in the data archive DA.

### SUMMARY OF THE INVENTION

The invention relates to a method of the generic type in which it is possible to verify the data integrity without using experts.

In one embodiment of the invention, by more or less permanently observing the data integrity of data records from the redundantly provided data records using a hash value signature, it is possible to identify that data record in which a data corruption, for example a bit error, has occurred. The uncorrupted data record is then used as the basis for restoring the redundancy, while the corrupted data record is rejected. This assumes it to be improbable that the same fault will occur in two data records at the same point at the same time. So as nevertheless to be able to identify such an event which is extremely improbable per se, it is possible to provide multiple redundancy, for example in the form of three identical data records.

By using this method, also called DAF (Data Archiving with Fingerprint), in cooperation with a hash value signature it is possible to verify any data record in the data archive under batch control, that is to say under command line control, in remote mode, that is to say from a distance, and to clearly identify the corrupted data record. The demonstrably uncorrupted data record on the redundant data storage medium can be used for tool-assisted restoration of the redundancy of the data management in the data archive without needing to activate the application and to call in experts.

A hash value is a scalar value which is calculated from a more complex data structure using a hash function. The cryptographic hash function converts the input data record into a short value of fixed length, the hash value. Hash algorithms are optimized to avoid “collisions”. A collision occurs when two different data structures are assigned the same hash value. With a good hash function, it is unlikely for there to be two data records which have the same hash value. In addition, small changes in the input data record in the case of a good hash function have a very great influence on the hash value. Spontaneous bit errors caused by aging phenomena in the data storage medium, for example, can be identified without difficulty by virtue of an altered hash value.

In one aspect of the invention, the hash value signature is generated using an MD4 (Message Digest) algorithm. In the case of this algorithm, variables change using nonlinear transformations on the basis of the input data, that is to say the redundantly provided data record which is to be checked for data integrity, and thereby form a unique hash value. The MD4 algorithm has provision for four variables which are used in the calculation of the hash value in three rounds. The MD4 algorithm has been developed by the claim to run particularly quickly on 32-bit computers and at the same time to be easy to implement. In this case, the fundamental demands on hash functions should naturally be retained. MD4 generates a hash value with a length of 128 bits. To achieve even greater certainty for demonstrating the data integrity, it is also possible to use a higher version of the MD algorithm, for example MD5.

In still another aspect of the invention, the archiving method may be used for long-term archiving, that is to say over a time period of up to thirty years, particularly of production and/or project files after the end of production or of the project. Tool-assisted verification of the data integrity with restoration of the redundancy may be used, by way of example, for safe long-term archiving of project-specific data from signal box projects in the case of safety-related rail applications, in medical engineering or in power station installations.

### BRIEF DESCRIPTION OF THE DRAWINGS

The invention is explained in more detail below with reference to illustrations in the figures, in which:

FIG. 1 shows a known archiving method in schematic illustration.

FIG. 2 shows an embodiment of an archiving method in a similar manner of illustration to that in FIG. 1.

### DETAILED DESCRIPTION OF THE INVENTION

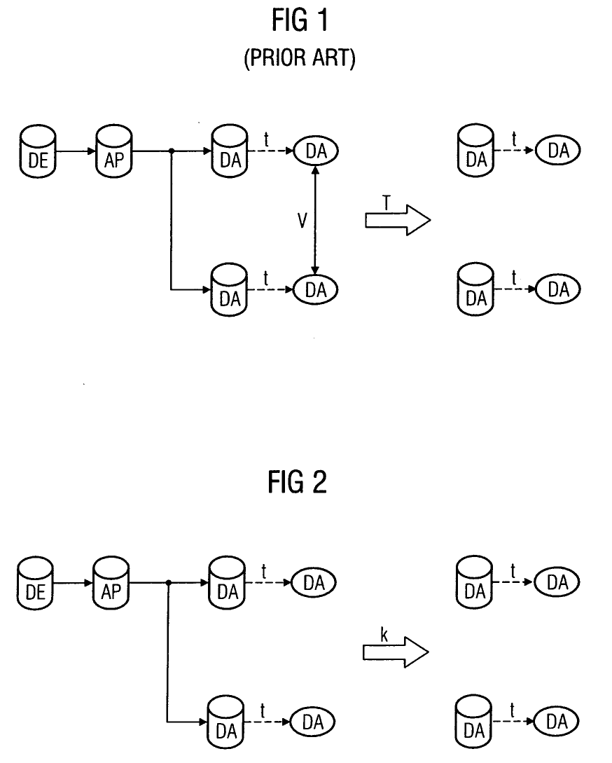

The known archiving method illustrated in FIG. 1 and described above is based on the comparison v of the data records redundantly stored in the data archive DA. In this case, it is possible to establish whether a difference has arisen between the two data records, but not which of the data records contains an error, for example an age-related error. To identify the erroneous data record, extensive data analysis is necessary which can be performed only by experts.

By contrast, the practice illustrated in FIG. 2 requires no comparison v of the redundant data records and also no reconstruction r of the original data record by experts. Instead, each data record is examined for data integrity separately on a continuous basis or in brief rotation. This is done using an MD4 (Message Digest) algorithm. If a data alteration is detected in one of the identical redundant data records, this data record is rejected and the integral data record is copied k to restore the data redundancy. This provides a simple way of archiving, particularly over relatively long time periods, and there is no need for data reconstruction r by experts in the event of an error.

The invention is not limited to the exemplary embodiment indicated above. Rather, a number of variants are possible which make use of the features of the invention even in a fundamentally different kind of embodiment.

1. A method for archiving data, comprising generating redundant data records having a data integrity monitored in rotation using a hash value signature, and if an error is detected with regard to the data integrity then an affected data record is rejected and an unaffected data record is copied to restore the redundancy.

2. The method as claimed in claim 1,
wherein the hash value signature is generated using an MD4 algorithm.

3. The method as claimed in claim 1, wherein
archiving production and/or project files occurs over a time period of between six and thirty years after an end of production or of a project.
